(19) United States
(12) Patent Application Publication
(10) Pub. No.: US 2013/0208214 A1
(43) Pub. Date: Aug. 15, 2013

(54) BACKLIGHT MODULE AND LIQUID CRYSTAL DISPLAY DEVICE

(71) Applicants: Jianfa Huang, Shenzhen (CN); Chechang Hu, Shenzhen (CN)

(72) Inventors: Jianfa Huang, Shenzhen (CN); Chechang Hu, Shenzhen (CN)

(73) Assignee: Shenzhen China Star Optoelectronics Technology Co., Ltd., Shenzhen (CN)

(21) Appl. No.: 13/501,632

(22) PCT Filed: Feb. 17, 2012
(86) PCT No.: PCT/CN12/71253

§ 371 Date: Apr. 12, 2012

(30) Foreign Application Priority Data
Feb. 15, 2012 (CN) 201210034142.0

(51) Int. Cl. G02F 1/13357; G09F 13/04

(52) U.S. Cl. 349/65; 362/606

(57) ABSTRACT

The present invention relates to a backlight module and a liquid crystal display (LCD) device, and the backlight module comprises a light guide plate, a base, a light source and a specular reflection plate. An included angle is provided between a light output surface of the light source and a light input surface of the light guide plate, and the included angle is smaller than 90 degree. The backlight module and the LCD device according to the present invention can increase the light coupling efficiency of the backlight module by changing the shape of the light output surface of the light source, so as to solve the technology problem that the light coupling efficiency of the traditional backlight module and the LCD device is relatively low.

### FIELD OF THE INVENTION

The present invention relates to a field of a liquid crystal display (LCD), and more particularly to a backlight module and an LCD device which can increase the light coupling efficiency.

### BACKGROUND OF THE INVENTION

A liquid crystal display (LCD) has been widely applied in various kinds of electric products, and most of the LCDs are backlight type LCD, which comprise an LCD panel and a backlight module. According to different incident positions of light sources, the backlight module can be divided into two types, a side-light type and a direct-light type, so as to provide the backlight sources to the LCD panel.

As shown in FIG. 1, a structural schematic view of a traditional side-light type backlight module of bottom-light-input is illustrated in FIG. 1, wherein numeral 101 is a light guide plate; numeral 102 is a light source; and numeral 103 is a specular reflection plate. The energy of light emitted from the light source 102 in the figure concentrates over the light source 102, and most of the light “A” need to be reflected by the specular reflection plate 103, so as to enter into the interior of the light guide plate 101. However, there are a portion of light “B” will return back to the light source 102 by the reflection of the specular reflection plate 103, so that this portion of the light can not enter into the light guide plate 101, so as to influence the light coupling efficiency of the backlight module. Hence, the energy utilization rate of the side-light type backlight module of bottom-light-input is lower by 12% to 15% than that of a traditional side-light type backlight module.

As a result, it is necessary to provide a backlight module and an LCD device to solve the problems existing in the conventional technologies.

### SUMMARY OF THE INVENTION

The present invention provides a backlight module and a liquid crystal display (LCD) device of bottom-light-input, which can increase the light coupling efficiency by changing the shape of a light output surface of a light source, so as to solve the technology problem that the light coupling efficiency of a traditional backlight module and an LCD device is relatively low.

The present invention relates to a backlight module, which comprises: a light guide plate; a base installed above or below a light input side of the light guide plate; a light source installed on the base; and a specular reflection plate reflecting light from the light source to a light input surface of the light guide plate; wherein an included angle is provided between a light output surface of the light source and the light input surface of the light guide plate, and the range of the included angle is from 40 to 80 degree; the light source is a light emitting diode (LED) light source, which comprises a light emitting chip and a corresponding LED shell body for packaging the light emitting chip, and an inner surface of the LED shell body is coated with a reflective film; the reflective film is a gold film or a silver film; and a light output surface of the light emitting chip is parallel to the light output surface of the light source.

The present invention relates to a backlight module, which comprises: a light guide plate; a base installed above or below a light input side of the light guide plate; a light source installed on the base; and a specular reflection plate reflecting light from the light source to a light input surface of the light guide plate; wherein an included angle is provided between a light output surface of the light source and the light input surface of the light guide plate, and the included angle is smaller than 90 degree.

In the backlight module of the present invention, the range of the included angle is from 40 to 80 degree.

In the backlight module of the present invention, the light source is an LED light source, which comprises a light emitting chip and a corresponding LED shell body for packaging the light emitting chip, and an inner surface of the LED shell body is coated with a reflective film.

In the backlight module of the present invention, the reflective film is a gold film or a silver film.

In the backlight module of the present invention, a light output surface of the light emitting chip is parallel to the light output surface of the light source.

In the backlight module of the present invention, a light output surface of the light emitting chip is perpendicular to the light input surface of the light guide plate.

In the backlight module of the present invention, the specular reflection plate is a single-surface type specular reflection, a multi-surface type specular reflection or a curved-surface type specular reflection.

In the backlight module of the present invention, the base is a printed circuit board.

The present invention further relates to an LCD device, which comprises a display panel and a backlight module, wherein the backlight module comprises: a light guide plate; a base installed above or below a light input side of the light guide plate; a light source installed on the base; and a specular reflection plate reflecting light from the light source to a light input surface of the light guide plate; wherein an included angle is provided between a light output surface of the light source and the light input surface of the light guide plate, and the included angle is smaller than 90 degree.

In the backlight module of the present invention, the range of the included angle is from 40 to 80 degree.

In the backlight module of the present invention, the light source is an LED light source, which comprises a light emitting chip and a corresponding LED shell body used for packaging the light emitting chip, and an inner surface of the LED shell body is coated with a reflective film.

In the LCD device of the present invention, the reflective film is a gold film or a silver film.

In the LCD device of the present invention, a light output surface of the light emitting chip is parallel to the light output surface of the light source.

In the LCD device of the present invention, a light output surface of the light emitting chip is perpendicular to the light input surface of the light guide plate.

In the LCD device of the present invention, the specular reflection plate is a single-surface type specular reflection, a multi-surface type specular reflection or a curved-surface type specular reflection.

In the LCD device of the present invention, the base is a printed circuit board.

Hence, the advantages of carrying out the backlight module and the LCD device according to the present invention are described, as follows: by changing the shape of a light output surface of a light source, it can increase the light coupling efficiency, so as to solve the technology problem that the light coupling efficiency of a traditional backlight module and an LCD device of bottom-light-input is relatively low.

For above-mention contents of the present invention can be best understood by referring to the following detailed description of the preferred embodiments and the accompanying drawings.

### DESCRIPTION OF THE DRAWINGS

FIG. 1 is a structural schematic view of a traditional side-light type backlight module of bottom-light-input;

FIG. 2 is a structural schematic view of a backlight module according to a preferred embodiment of the present invention;

FIG. 3 is a structural schematic view of a light source of a backlight module according to a first preferred embodiment of the present invention; and

FIG. 4 is a structural schematic view of a light source of a backlight module according to a second preferred embodiment of the present invention.

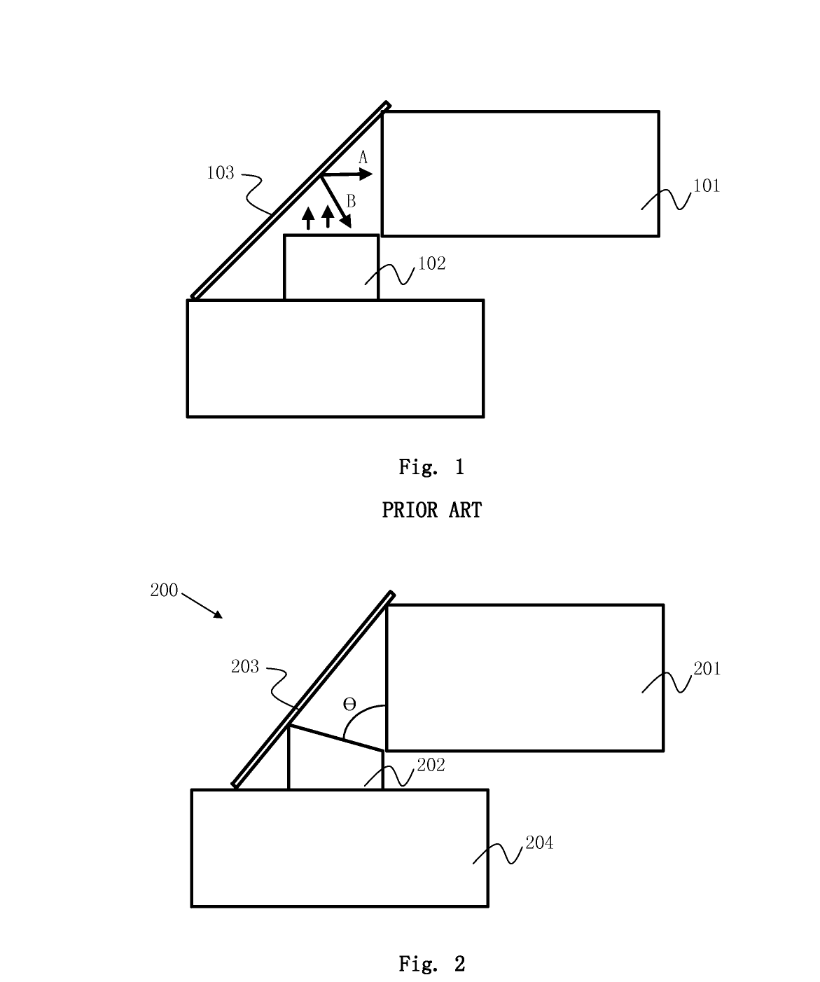

### DETAILED DESCRIPTION OF THE PREFERRED EMBODIMENTS

The description of the preferred embodiments refers to the drawings, so as to illustrate the specific embodiments of the present invention which can be carried out. Furthermore, the directional terms described in the present invention, such as upper, lower, front, rear, left, right, inner, outer, side and etc., are only directions referring to the accompanying drawings, so that the used directional terms are used to describe and understand the present invention, but the present invention is not limited thereto.

In the drawings, the units with the similar structure use the same numerals.

Referring now to FIG. 2, a structural schematic view of a backlight module according to a preferred embodiment of the present invention is illustrated in FIG. 2. In this preferred embodiment, the backlight module 200 according to the present invention is a side-light type backlight module of bottom-light-input. The backlight module 200 comprises a light guide plate 201, a base 204, a light source 202 and a specular reflection plate 203. The light guide plate 201 is used to even and expend the light from the light source 202 to a display panel for displaying image; the base 204 is installed above or below a light input side of the light guide plate 201; the light source 202 is installed on the base 204; and the specular reflection plate 203 is also installed at the light input side of the light guide plate 201 for reflecting the light from the light source 202 to a light input surface of the light guide plate 201. In this preferred embodiment, there is a predetermined angle ⊖ between a light output surface of the light source 202 and the light input surface of the light guide plate 201, and the predetermined angle ⊖ is smaller than 90 degree.

The specular reflection plate 203 according to the present invention can be a single-surface type specular reflection, a multi-surface type specular reflection or a curved-surface type specular reflection. The base 204 can be a printed circuit board. The light source 202 is such as a cold cathode fluorescent lamp (CCFL), a light emitting diode (LED), an organic light emitting diode (OLED), an electro-luminescence (EL), an light Bar or anyone combined by above-mentioned, and is preferably be an LED light source.

When the backlight module 200 according to the present invention is in operation, the light emitted from the light source 202 enter into the light guide plate 201 reflected mainly by the specular reflection plate 203, or back to the light source 202 reflected by the specular reflection plate 203. However, because the predetermined angle ⊖ between the light output surface of the light source 202 and the light input surface of the light guide plate 201 is smaller than 90 degree, a part of the light emitted from the light source 202 can directly enter into the light guide plate 201, so it causes the light which back to the light source 202 reflected by the specular reflection plate 203 are decreased, so that the light coupling efficiency of the backlight module 200 is increased.

The less the predetermined angle is, the more the light coupling efficiency of the backlight module 200 will be. But, when the predetermined angle ⊖ is decreased to a specific value, the speedup of the light coupling efficiency of the backlight module 200 will be obviously lowered, and now the backlight module 200 is easy to appear with a hot spot Mura phenomenon, namely, the light input side of the light guide plate 201 will appears with a halo of period arrangement, so as to influence the display effect of the LCD device. It is proved by experiment, when the range of the predetermined angle ⊖ is from 40 to 80 degree, the backlight module 200 has better light coupling efficiency. Please specifically refer to the experiment data of Table 1 as follow:

TABLE 1

| included angle between | | |
|---|---|---|
| light output surface of | | |
| light source and light | luminous flux | |
| input surface of light | (80 lm when light coupling | light coupling |
| guide plate | efficiency is 100%) | efficiency |
| 90 | 60.5 lm | 75.60% |
| 80 | 64.1 | 80.13% |
| 70 | 66.2 | 82.75% |
| 60 | 67.9 | 84.88% |
| 50 | 68.5 | 85.63% |
| 40 | 68.8 | 86% |

As it can be seen from the data of Table 1, when the predetermined angle ⊖ is changed from 90 degree (same as the side-light type backlight module of bottom-light-input in traditional technology) to 80 degree, the light coupling efficiency of the backlight module 200 will be increased 5%, but when the predetermined angle ⊖ is decreased by degree. When the included angle between the light output surface of the light source and the light input surface of the light guide plate is decreased per 10 degree, the increased light coupling efficiency of the backlight module 200 are respectively be 1.6%, 2.1%, 0.8% and 0.4%. Therefore, when the predetermined angle ⊖ is smaller than 40 degree, the increasing of the light coupling efficiency of the backlight module is limited so much, and now the backlight module appears with a hot spot Mura phenomenon. Hence, the better degree range of the included angle between the light output surface of light source and the light input surface of light guide plate is from 40 to 80 degree.

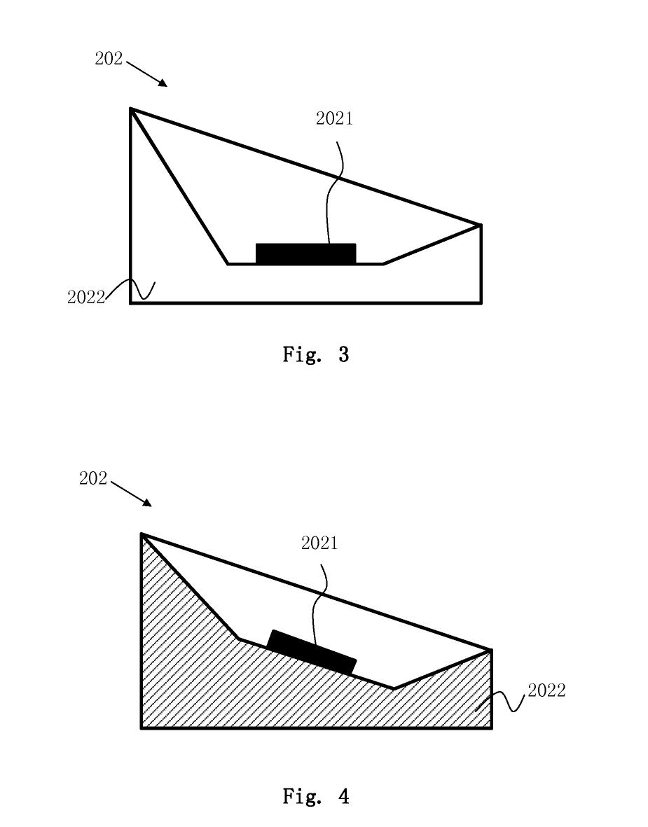

As a preferred embodiment of the backlight module according to the present invention, the light sources 202 of the backlight module 200 according to the present invention is used an LED light source, and the LED light source comprises a light emitting chip 2021 and a corresponding LED shell body 2022, wherein the LED shell body 2022 is used for packaging the light emitting chip 2021. FIG. 3 and FIG. 4 are respectively be a structural schematic view of a backlight module according to a first preferred embodiment of the present invention and a structural schematic view of a backlight module according to a second preferred embodiment of the present invention.

For ensuring the reliability of the light source 220, the light emitting chip 2021 is generally packaged by the LED shell body 2022 to form as the LED light source. Meanwhile, an inner surface of the LED shell body 2022 is coated with a reflective film, so as to increase the reflective ability of the LED shell body 2022, wherein the reflective film is preferably be a gold film or q silver film. The light emitting chip 2021 can use various kinds of methods to mount into the LED shell body 2022. Such as shown in FIG. 3, the light output surface of the light emitting chip 2021 can be perpendicular to the light input surface of the light guide plate 201, and this kind of design is simpler in structure, and the design cost thereof is lower. So as shown in FIG. 4, the light output surface of the light emitting chip 2021 is parallel to the light output surface of the light source 220, and this kind of design is slight complex in structure, but because the light output surface of the light emitting chip 2021 is parallel to the light output surface of the light source 220, the most of the light emitted from the light emitting chip 2021 can directly emit out, not necessary to be reflected by the reflective film of the LED shell body 2022, so as to increase the directing luminous flux.

The present invention further relates to a liquid crystal display device, which comprises a display panel and backlight module, wherein the backlight module comprises a light guide plate, a base, a light source and a specular reflection plate. The light guide plate is used to even and expend a light from a light source to a display panel for displaying image; the base is installed above or below a light input side of the light guide plate; the light source is installed on the base; and the specular reflection plate is also installed at the light input side of the light guide plate for reflecting the light from the light source to the light input surface of the light guide plate. In this preferred embodiment, there is a predetermined angle ⊖ between a light output surface of the light source and the light input surface of the light guide plate, and the predetermined angle ⊖ is smaller than 90 degree, wherein the better degree range of the included angle between the light output surface of light source and the light input surface of light guide plate is from 40 to 80 degree. The working principle and beneficial effect of the LCD device according to the present invention is same or similar to the specific preferred embodiment of above-mentioned backlight module, so please specifically refer to the specific preferred embodiment of above-mentioned backlight module.

The advantages of the backlight module and the LCD device according to the present invention are as follows: by changing the shape of the light output surface of the light source, to increase the light coupling efficiency of the backlight module; meanwhile, by choosing the included angle between the light output surface of light source and the light input surface of light guide plate, to effectively avoid appearing the hot spot Mura phenomenon of backlight module; furthermore, to achieve the best utilization effect for the light source by that users can use various kinds of methods to package the light source of the backlight module according to the present invention; and to well solve the technology problem that the light coupling efficiency of the traditional backlight module of bottom-light-input is relatively low.

As described above, the present invention has been described with a preferred embodiment thereof and it is understood that many changes and modifications to the described embodiment can be carried out without departing from the scope and the spirit of the invention that is intended to be limited only by the appended claims.

1. A backlight module, characterized in that: the backlight module comprises:
a light guide plate;
a base installed above or below a light input side of the light guide plate;
a light source installed on the base; and
a specular reflection plate reflecting light emitted from the light source to a light input surface of the light guide plate;
wherein an included angle is provided between a light output surface of the light source and the light input surface of the light guide plate, and the range of the included angle is from 40 to 80 degree;
the light source is a light emitting diode (LED) light source, which comprises a light emitting chip and a corresponding LED shell body for packaging the light emitting chip, and an inner surface of the LED shell body is coated with a reflective film;
the reflective film is a gold film or a silver film; and
a light output surface of the light emitting chip is parallel to the light output surface of the light source.

2. A backlight module, characterized in that: the backlight module comprises:
a light guide plate;
a base installed above or below a light input side of the light guide plate;
a light source installed on the base; and
a specular reflection plate reflecting light from the light source to a light input surface of the light guide plate;
wherein an included angle is provided between a light output surface of the light source and the light input surface of the light guide plate, and the included angle is smaller than 90 degree.

3. The backlight module according to claim 2, characterized in that: the range of the included angle is from 40 to 80 degree.

4. The backlight module according to claim 2, characterized in that: the light source is an LED light source, which comprises a light emitting chip and a corresponding LED shell body for packaging the light emitting chip, and an inner surface of the LED shell body is coated with a reflective film.

5. The backlight module according to claim 4, characterized in that: the reflective film is a gold film or a silver film.

6. The backlight module according to claim 4, characterized in that: a light output surface of the light emitting chip is parallel to the light output surface of the light source.

7. The backlight module according to claim 4, characterized in that: a light output surface of the light emitting chip is perpendicular to the light input surface of the light guide plate.

8. The backlight module according to claim 2, characterized in that: the specular reflection plate is a single-surface type specular reflection, a multi-surface type specular reflection or a curved-surface type specular reflection.

9. The backlight module according to claim 2, characterized in that: the base is a printed circuit board.

10. A liquid crystal display (LCD) device, characterized in that: the LCD device comprises a display panel and a backlight module, wherein the backlight module comprises:
a light guide plate;
a base installed above or below a light input side of the light guide plate;
a light source installed on the base; and
a specular reflection plate reflecting light from the light source to a light input surface of the light guide plate;
wherein an included angle is provided between a light output surface of the light source and the light input surface of the light guide plate, and the included angle is smaller than 90 degree.

11. The LCD device according to claim 10, characterized in that: the range of the included angle is from 40 to 80 degree.

12. The LCD device according to claim 10, characterized in that: the light source is an LED light source, which comprises a light emitting chip and a corresponding LED shell body for packaging the light emitting chip, and an inner surface of the LED shell body is coated with a reflective film.

13. The LCD device according to claim 12, characterized in that: the reflective film is a gold film or a silver film.

14. The LCD device according to claim 12, characterized in that: a light output surface of the light emitting chip is parallel to the light output surface of the light source.

15. The LCD device according to claim 12, characterized in that: a light output surface of the light emitting chip is perpendicular to the light input surface of the light guide plate.

16. The LCD device according to claim 10, characterized in that: the specular reflection plate is a single-surface type specular reflection, a multi-surface type specular reflection or a curved-surface type specular reflection.

17. The LCD device according to claim 10, characterized in that: the base is a printed circuit board.
